(19) United States
(12) Patent Application Publication
(10) Pub. No.: US 2014/0152665 A1
(43) Pub. Date: Jun. 5, 2014

(54) MULTI-MEDIA COLLABORATOR

(71) Applicant: SAP AG, Walldorf (DE)

(72) Inventors: Hai Yun LU, Singapore (SG); Marek Konrad KOWALKIEWICZ, Singapore (SG)

(73) Assignee: SAP AG, Walldorf (DE)

(21) Appl. No.: 13/689,774

(22) Filed: Nov. 30, 2012

(51) Int. Cl. G06T 11/20

(52) U.S. Cl. CPC G06T 11/206
USPC 345/440

(57) ABSTRACT

Described herein is a technology for facilitating multi-media collaboration. In some implementations, a digital image with hand drawings is provided at a local location of a collaboration. A graph is formed from the digital image. Connected components (CCs) in the graph are identified. Text CCs in the graph is classified. The text CCs from the graph is segmented. Objects and data of the text CCs are propagated to participants of the collaboration at other remote locations.

### TECHNICAL FIELD

The present disclosure relates generally to system and method for facilitating multi-media collaboration.

### BACKGROUND

Collaborative teams are often formed to brainstorm and produce some type of output. For example, collaborative teams can work together in a creative environment to develop a layout of a website or to define a business process. Early stages of discussion in creative environments often benefit from a “pen and packing paper” approach, during which team members each contribute to the collaborative effort using traditional brainstorming tools such as on a whiteboard, sticky notes, markers and pens.

In some situations, members of a collaborative team can be remotely located from one another. For example, one or more team members can be working at a first location and one or more team members can be working at a second location that is some distance from the first location (e.g., on a different continent). Collaboration tools have been developed to enable remotely located team members to partake in collaborative efforts. Such collaboration tools, however, do not enable team members to use the above-mentioned traditional brainstorming tools to share information and collaborate with other team members at remotes locations. Consequently, team members that are virtually participating in a collaborative exercise are practically blind to events once the activity begins.

It is therefore desirable to provide tools which facilitate multi-media collaboration.

### SUMMARY

A computer-implemented technology for facilitating multi-media collaboration is described herein. The method includes providing, at a local location of a collaboration, a digital image with hand drawings. The method also includes forming a graph from the digital image. Connected components (CCs) in the graph are identified. Text CCs in the graph is classified. The text CCs are segmented from the graph. The method also includes propagating objects and data of the text CCs to participants of the collaboration at other remote locations.

In one embodiment, a non-transitory computer-readable medium having stored thereon program code is disclosed. The program code is executable by a computer. The program code includes capturing a digital image with hand drawings at a local location. The program code also includes forming a graph from the digital image. Connected components (CCs) in the graph are identified. Text CCs in the graph are classified. The program code also includes segmenting the text CCs from the graph.

In yet another embodiment, a multi-media collaboration system is disclosed. The system includes a non-transitory memory device for storing computer-readable program code. The system also includes a processor in communication with the memory device. The processor is being operative with the computer-readable program code to perform capturing a digital image with hand drawings by a digital camera in communication with the processor, forming a graph from the digital image, identifying connected components (CCs) in the graph, classifying text CCs in the graph and segmenting the text CCs from the graph.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 depicts an example of a system;

FIG. 2 is a block diagram of an embodiment of an architecture for a multi-media collaborator;

FIGS. 3A-3C depict a progression of an example collaboration;

FIG. 4 is a flowchart of an embodiment of a process for facilitating multi-media collaboration;

FIG. 5A shows an embodiment of a process for detecting and segmenting handwritten text;

FIG. 5B shows an embodiment of a process graph building;

FIG. 6 shows an example of binarizing an image of a physical work surface;

FIG. 7A shows various types of pixel condition in a binary image;

FIG. 7B shows a binary image after line thinning;

FIG. 8A shows examples of line tracing;

FIG. 8B shows examples of GS images after line thinning;

FIG. 9 shows examples of GS images with identified connected components and text connected components;

FIG. 10 shows examples of segmentation of text from images;

FIGS. 11A₁-E₁ show digital images of a work surface; and

FIGS. 11A₂-E₂ show results of text segmentation.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

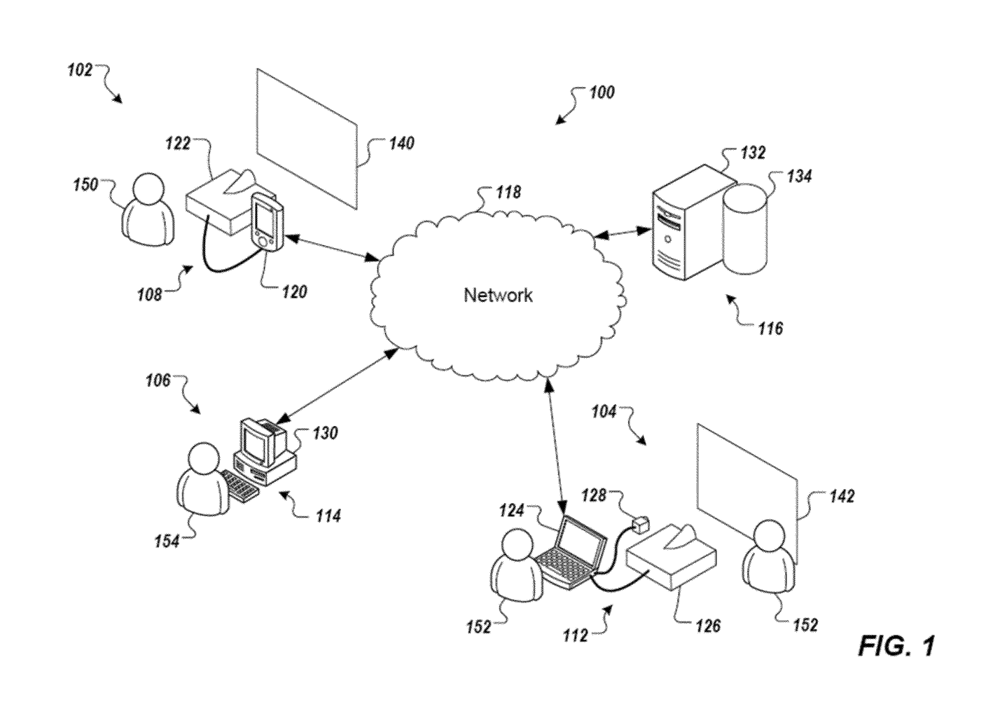

FIG. 1 depicts an example of a system 100. In one embodiment, the system is a multi-media (MM) collaboration system. The system, for example, may be realized using various hardware and software components. For example, the hardware components may include computing devices, digital cameras and digital projectors. Other types of components may also be included. The digital cameras may be still cameras and/or video cameras. The digital cameras may be discrete cameras which can communicate with processing device or integrated cameras with processing capabilities, such as smart phone or computers. The cameras preferably are high resolution cameras. The resolution of the cameras should be sufficient for detecting and digitizing text in captured images by computing devices. For example, an image of a physical work surface with text captured by the digital camera should have sufficient resolution such that it can be processed to reproduce the text in digital form.

The system includes a plurality of locations. The system is illustratively provided with first, second and third locations 102, 104 and 106. The example system further includes first, second and third hardware devices 108, 112 and 114 located at the first, second and third locations, respectively, a server system 116 and a network 118. A hardware device may include one or more hardware components. A hardware device includes at least a computing device. For example, the first hardware device includes a first computing device 120 and a first digital projector 122, the second hardware device includes a second computing device 124, a second digital projector 126 and a second digital camera 128 and the third hardware device includes a third computing device 130.

A computing device may be any appropriate type of computing device, such as a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. Illustratively, the first computing device is depicted as a smart phone, the second computing device is depicted as a laptop computer and the third computing device is depicted as a desktop computer. Other configurations of computing devices may also be useful.

The computing devices can communicate with one another and/or the server system over the network. The network can include a large computer network, such as a local area network (LAN), a wide area network (WAN), the Internet, a cellular network, or a combination thereof connecting any number of mobile computing devices, fixed computing devices and server systems. The server system 116 can include one or more computing devices 132 and one or more machine-readable repositories or databases 134. Various techniques may be employed to connect the computing devices and server system to the network. For example, the computing devices and server system may be connected to the network by wired and/or wireless connection.

As shown, the first computing device is in communication with the first digital projector of the first location. In addition, a physical work surface 140 is provided at the first location. Various types of physical work surfaces may be provided. For example, the physical work surface can include a whiteboard and/or a sheet of paper (e.g., packing paper) hung on a wall. Other types of work surfaces may also be useful. For example, any type of physical work surface which can be written or drawn on may be useful. Preferably, the work surface should have a color, such as white. Other types of colors or work surfaces may also be useful. The first computing device, which is a smart phone, includes an integrated digital camera that can be provided as a still camera and/or a video camera. The digital camera can be arranged to capture images of the physical work surface while the digital projector can be arranged to project images onto the work surface.

As for the second computing device, which is a laptop computer, it is in communication with the second digital projector and the second digital camera of the second location. In addition, a physical work surface 142 is provided. The digital camera can be arranged to capture images of the work surface and the digital projector can be arranged to project images onto the work surface. The third computing device, which is a desktop computer, includes a virtual work surface. For example, the virtual work surface may be a web browser which allows drawings and writing using an input device, such as keyboard and mouse or a touch screen. Other types of virtual work surfaces may also be useful.

The locations may include one or more team members. For example, one or more team members 150 can be present at the first location, one or more team members 152 can be present at the second location and one or more team members 154 can be present at the third location. The team members of the first and second locations may be deemed to be active participants in the collaboration in that physical media (e.g., physical work surface) is locally available to participate in the collaborative effort while the team members of the third location may be deemed to be virtual participants in that they are not using physical media to physically participate in the collaboration.

The work surfaces, whether physical or virtual, may be considered graphical editors. A graphical editor can be used to perform a sequence of operations. As an example, an operation can include adding, moving or deleting handwritten text and drawings to a work surface. Other types of operations may also be useful. For example, operations may include adding, moving or removing a sticky note to a work surface. Furthermore, an operation may include underlying primitive operations. Primitive operations can include creating a new object, setting one or more properties of the object, and adding the object to an object pool. In the context of a collaboration, the operations preserve the intention of the team member and are therefore applied in their entireties or not at all. Furthermore, operations of other team members have to be seen in the light of another team member's changes. Therefore, a team member would have to transform other team member's operations against his own operations.

As described, the system has a client/server (C/S) architecture. The C/S architecture is a distributed client/server architecture. For example, the computing devices at the locations may be referred to as clients which are communicatively coupled to the server via the network. Other types of architectures may also be useful. In some cases, the server may be a cloud computing server. Other types of architectures may also be useful.

The system uses operational transformation (OT) to maintain consistency of distributed documents which are subject to concurrent changes and to support real-time collaborative editing of software models. OT may employ various types of software modeling languages, such as uniform modeling language (UML) and/or business process modeling notation (BPMN). Other types of software modeling languages may also be useful. A collaborative effort or collaboration can include an underlying model that is manipulated by editing, adding, deleting and/or connecting, for example, objects of the model. OT enables synchronization of the work surfaces (e.g., as graphical editors) and their underlying data structure (i.e., the model). Each computing device or client can maintain a local model of the respective work surfaces. In some implementations, the computing devices manipulate the models by correlating team member action (e.g., adding handwritten text and deleting handwritten text) into complex operations. Through an OT process, discussed in further detail herein, a complex operation is transformed into its constituent primitive operations, while preserving the team member's intention.

In accordance with OT, the underlying data structure (i.e., the model) is manipulated based on the primitive operations. The primitive operations are subjected to the operational transformation, to synchronize the model across the clients (e.g., the computing devices at the different locations) and a central coordinator (e.g., the server system). Operational transformations specify how one operation (e.g., addition of handwritten text onto a work surface) is to be transformed against another operation (e.g., deletion of handwritten text from the work surface). In some implementations, OTs can include an inclusive transformation (IT) and an exclusive transformation (ET). An IT transforms two operations such that the resulting operation includes the effects of both operations. An ET transforms two operations such that the effects of one operation are excluded by the other operation.

The clients each execute software for recognizing and translating physical operations as graphical editor operations for visualizing and manipulating the underlying object graph through complex editor operations made up of primitive operations. The server system is not required to be aware of the editor operations, which can be dependent on the actual application domain. In this manner, the server system can handle various modeling languages (e.g., UML, BPMN, and/or any domain specific language).

In one embodiment, each client (e.g., computing devices at the different locations) conforms to a client protocol. Before discussing details of the client protocol, general activities of a client are discussed. Upon recognizing the occurrence of a complex operation, a client performs the complex operation on the local model. For example, after handwritten text is added to the work surface at the first location, the first computing device generates an activity corresponding to the handwritten text and augments the local model that is maintained by the first computing device. After the client has augmented the local model, the client transmits the complex operation to the server (e.g., the server system). After transmitting the complex operation to the server, the client waits for an acknowledgment from the server before being able to submit more operations. In some implementations, the client can queue complex operations to enable the client to be responsive to team member interactions and keep changing the local model without the acknowledgment from the server.

With regard to details of the client protocol, once a client generates a complex operation (e.g., add a new activity) an apply procedure is called and the operation is passed. Here it is assumed that no other changes to the local model can be made between the generation of an operation and calling the apply procedure. The client executes the operation on the local model, adds the operation to a local operation history and to a queue of pending operations. If the client is currently not waiting for an acknowledgment from the server (e.g., in response to a previous operation), the client sends the queue to the server and waits for an acknowledgment. If the client is waiting for an acknowledgment from the server (e.g., in response to a previous operation), the operation is added to the queue to be sent later.

The server can notify a client (e.g., the second computing device) of a sequence of operations to be applied by the client to its local model. The client receives operations via a receive procedure. Upon receiving operations from the server, the client applies the operations in the sequence to augment the local model. If any of the operations sent by the server are in conflict with operations that have already been locally applied by the client, the previously applied, conflicting operations are undone, and the operations provided by the server are applied. This means that the queue of pending operations to be sent and/or acknowledged by the server also may have changed such that operations that have been undone are removed from the queue as well.

Another way for the server to interact with a client is by acknowledging the receipt and the successful transformation and application of an operation originating from the particular client. This is achieved by calling an acknowledge procedure on the client. The acknowledged operations are removed from the list of to be acknowledged operations. If the queue of pending operations is not empty, the operations are sent to the server.

The server (e.g., server system) conforms to a server protocol. Before discussing details of the server protocol, general activities of the server are discussed. The server receives a complex operation from a client and applies the complex operation to the model maintained at the server. The server transmits transformed operations to all other clients. The server only transmits operations that have been transformed against a local history of operations at the server, and transmits an acknowledgment to the client that originally sent the operation. In this manner, clients only transform operations back until the last acknowledgment.

With regard to details of the server protocol, the server protocol can include a receive procedure, which is called to initiate transmission of a sequence of complex operations to the server. A client that sends operations to the server identifies itself by also passing a unique identifier (cid). The server translates the sequence of complex operations, one by one, and appends the result to a list of operations. If a conflict occurs, translation of the remaining operations is abandoned. The server acknowledges the receipt of original operations to the originating client and broadcasts the translated operations to the other clients.

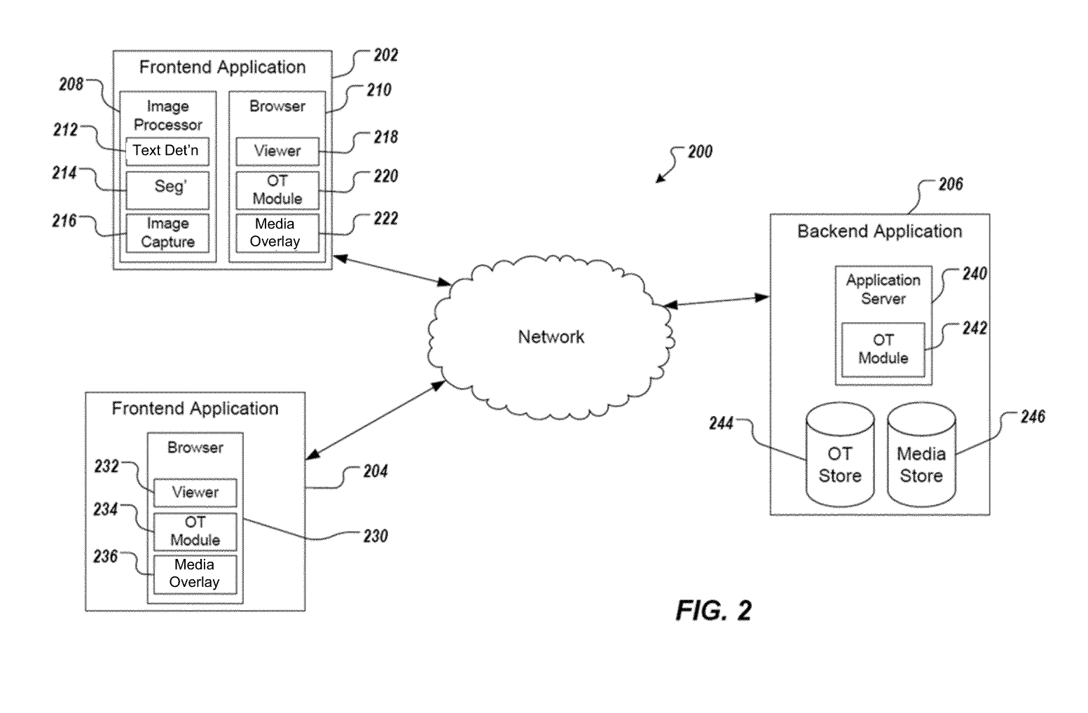

FIG. 2 is a block diagram of an embodiment of multi-media collaborator architecture 200. The architecture includes software components. The software components, for example, may include software applications, application modules and/or sub-modules that can be executed using one or more processors. As described, the system has a C/S architecture. In a C/S architecture, client components for clients and a server component for the server are provided. For example, client components are frontend applications for execution at the clients and the server component is a backend application for execution at the server. It is understood that the frontend applications need not be of the same configuration. The components are configured to facilitate real time collaboration.

The software architecture, for example, is configured for the system described in FIG. 1. Providing software architectures with components configured for other systems may also be useful. In one embodiment, the software architecture includes first and second frontend applications 202 and 204 and a backend application 206. The first and second frontend applications are provided for clients and the backend application is configured for the server system. The frontend and backend applications may include one or more applications, application modules and/or sub-modules. For example, the frontend applications may include one or more applications, application modules and/or sub-modules which are executed by computing systems at the clients and the backend application may include one or more applications, application modules and/or sub-modules for execution by the server system.

In one embodiment, a frontend application includes a browser module 210. For example, the frontend application operating at the first, second and third clients include a browser module. The browser module includes a viewer sub-module 218, an OT sub-module 220 and a media overlay sub-module 222. The viewer sub-module 218 is used to process data and to initiate the display of content received from remote computing devices as a projection on a work surface. The OT sub-module 220 is a client-side sub-module that processes data to propagate all changes of a client (team member) within the collaboration to all other clients (team members) involved. The media overlay sub-module 222 enables team members to overlay physical media, such as handwritten text, with a map or video to provide different types of multi-media experiences as part of the collaboration (e.g., maps, videos, images, etc.).

In the case of a client which requires support for collaborating on a physical work surface, the frontend application includes an image processor module 208. For example, the first frontend application includes the image processor module along with the browser module. In one embodiment, the image processor module 208 includes a text detection sub-module 212, a text segmentation sub-module 214 and an image capture sub-module 216. The image capture sub-module is used to capture an image of a work surface. The text detection sub-module is used to identify text from drawings on a work surface. For example, the text detection sub-module identifies text from drawings in the image data. The text segmentation sub-module is used to segment the text on the work surface. For example, the text segmentation sub-module determines the shape of the text and segments detected text from the image data of the work surface. In one embodiment, the OT sub-module of the browser module is used to transform the segmentation results into operations, such as adding, editing or removing text, and to propagate changes to other computing devices.

The frontend applications may include other modules or software applications. For example, the frontend applications may include the business or enterprise software applications. Various types of business applications may be included. The business application, for example, maintains data of a business and creates business reports relating to the data. Such business applications may include, for example, SAP Crystal Solutions, including Xcelsius, Crystal Reports, Web Intelligence from SAP AG. Other types of business applications or suites of business applications may also be useful.

The backend application can include an application server module 240 that includes a server OT sub-module 242. The backend application can include and/or communicate with an OT store 244 and a media store 246. The server OT sub-module is a server-side component that receives all changes from all client computing devices, maintains a consistent state of the collaboration and propagates changes to all client computing devices accordingly. For example, the server OT sub-module can publish changes in the publish/subscribe paradigm. The OT store can be provided in computer-readable memory, such as a database or other types of memory storage, and can be used to persist all changes that occur during the collaboration. The media store can be provided in computer-readable memory, such as a database or other types of memory storage, and can be used to persist images (e.g., text detected on the work surfaces) from the client computing devices and other multi-media content generated or otherwise used during the collaboration. The backend application may include other modules, software applications or databases to support other software applications in the frontend application.

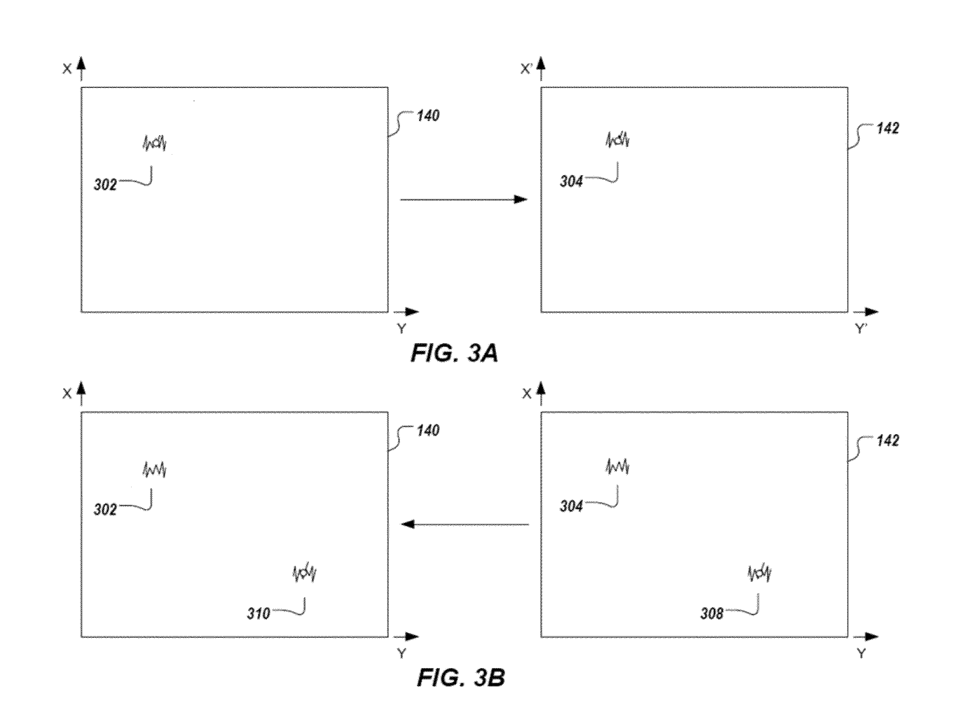

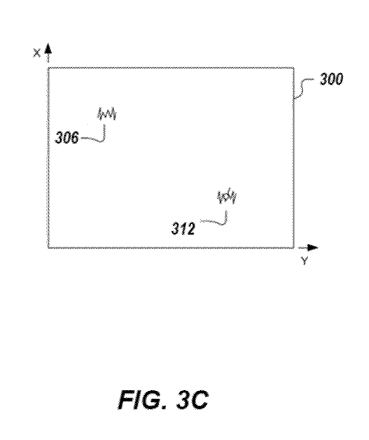

FIGS. 3A-3C depict progression of an example of a collaboration. FIGS. 3A and 3B depict first and second physical work surfaces 140 and 142. The first work surface, for example, is at a first location and the second work surface is at a second location. FIG. 3C depicts a virtual work surface 300. The virtual work surface, for example, is a virtual work surface of a web browser. The virtual work surface may be on a display screen of a computing device. Other types of virtual work surfaces may also be useful. For example, the virtual work surface may be a monitor coupled to a computing device or a smart TV with processing capabilities. The virtual work surface may be located at a third location. The progression, for example, reflects the exemplary system described in FIG. 1. Providing progressions of other collaborations reflecting other system configurations may also be useful.

A remote work surface refers to a work surface at other client locations with respect to a local work surface. For example, for a team member at the first location, the work surfaces at the second and third locations are remote work surfaces while the work surface at the first location is a local work surface.

Initially, a session is instantiated between the computing devices that are used in the collaboration. In some implementations, instantiation of the session can include providing a local model at each of the computing devices participating in the session and a consistency model at the server system. Each model models objects and relationships between objects defined during the session. In some implementations, each model can be generated as a new model corresponding to a new session. In some implementations, each model can be retrieved from computer-readable memory and can correspond to a previous session (e.g., the current session is a continuation of the previous session).

As shown in FIG. 3A, a team member at the first location adds handwritten text 302 to the first physical work surface. Image data corresponding to the first work surface is generated by, for example, the digital camera of the first computing device. The computing device, using the first frontend application, processes the image data to recognize that new handwritten text has been detected on the first work surface. A position (X₁, Y₁) of the text on the work surface 140 is determined. An image of the text is segmented from the image data. The image can be stored in computer-readable memory of the first computing device and is transmitted for storage at the backend server system. For example, the image can be stored in computer-readable memory of the server system and may include a corresponding URI. The backend server system assigns the URI to the image data and propagates the URI to the other computing devices of the collaboration. For example, the information is propagated to the second and third computing devices. Generation of and assignment of the URI on the server-side ensures uniqueness of the URI.

The OT sub-module translates the physical application of the handwritten text as an operation that is performed on the local model. In the instant example, addition of the text can be translated as the addition of a new object to the model. The operation can be committed to the local model of the computing device at the first location and is transmitted to the server system.

The server system receives the operation and executes the backend application to process the operation in view of a locally-stored history of operations and the consistency model. In particular, the OT sub-module of the application server module processes the operation to determine whether there is any conflict with previously received and committed operations.

In the instant example, there is no conflict. For example, there is no other activity performed by other team members at other locations prior to the addition of text by the team member at the first location. When there is no conflict, the server system augments the consistency model and transmits an acknowledgement to the originating computing device, (i.e., the first computing device). The server system propagates the operation to each of the other computing devices (i.e., the second and third computing devices), as well as the URI and position of the object.

For example, the second computing device receives the operation and object data from the server system and processes the operation and object data using its browser module. The second computing device generates image data based on the object data (i.e., the URI and the position) and provides the image data to, for example, the digital projector. The digital projector projects an image of handwritten text 304 (virtual text) onto the second work surface 142 at a position which corresponds to the position of the text at the first work surface. In this manner, the physical text from the first location is augmented to the second location as a virtual text. In some implementations, the virtual text note can include a color that is different from a color of the physical text. The OT sub-module of the second computing device processes the operation to update the local model. For example, the local model at the second location has a model object added that corresponds to physical text at the first location. In this manner, the local models of the computing devices at the first and second locations and the consistency model of the server system are synchronized.

The third computing device also receives the operation and object data from the server system and processes the operation and object data using its browser module. The third computing device generates image data based on the object data (i.e., the URI and the position) and provides the image data to the display, such as the monitor of the third computing device. The display displays a virtual text 306 on a virtual work surface 300 at a position corresponding to the position of the physical text at the first location, as shown in FIG. 3C. In this manner, the text from the first location is augmented to the third location as virtual text. The OT sub-module of the third computing device processes the operation to update the local model. For example, the local model at the third location has a model object added that corresponds to physical text at the first location. In this manner, the local model of the third computing device is synchronized with the local models of the first and second computing devices and the consistency model of the server system.

In FIG. 3B, a second team member at the second location adds physical text 308 on the second work surface. Image data corresponding to the second work surface is generated by the digital camera at the second location and is transmitted to the second computing device. The second computing device, using its frontend application, processes the image data to recognize that new text has been detected on the second work surface. A position of the new text on the second work surface is determined. An image of the new text is segmented from the image data. The image is stored in computer-readable memory of the second computing device. The image is also transmitted for storage at the backend server system. The image can be stored in computer-readable memory of the server system and includes a corresponding URI. For example, the OT sub-module of the frontend application executed on the second computing device propagates the position and the URI of the image to the server system.

The OT sub-module of the second computing device translates the physical application of text as an operation that is performed on the local model. In the instant example, the addition of text can be translated as the addition of a new object to the model. The operation can be committed to the local model of the second computing device and is transmitted to the server system.

The server system receives the operation and executes the backend application to process the operation in view of the locally-stored history of operations and the consistency model. In particular, the OT sub-module of the application server module processes the operation to determine whether there is any conflict with previously received and committed operations. In the instant example, there is no conflict. For example, team members at the second location added text after the text at the first location was added and before any other activity is performed by other team members at other locations. Consequently, the server system augments the consistency model and transmits an acknowledgement to the originating computing device, for example, the second computing device. The server system propagates the operation to each of the other computing devices, such as the first and third computing devices, as well as the URI and position of the object.

The first computing device receives the operation and object data from the server system and processes the operation and object data using the browser module. The computing device generates image data based on the object data, for example, the URI and position, and provides the image data to the digital projector at the first computing device. The digital projector projects a text 310 onto the first work surface. The virtual text is projected at a position corresponding to the position of the added physical text in the second work surface. In this manner, added text from the second location is augmented to the first location as the virtual texts. In some implementations, the virtual text can include a color that is different from a color of the physical text at the second location. The OT sub-module processes the operation to update the local model of the first computing device 120. In this manner, the local models of the first and second computing devices and the consistency model of the server system are synchronized.

The third computing device also receives the operation and object data from the server system and processes the object data using the browser module. The third computing device generates image data based on the object data and provides the image data to the display. As shown in FIG. 3C, the display displays a virtual text 312 of the physical text at the second location on the virtual work surface. The virtual text is projected at a position corresponding to the position of the added physical text in the second work surface. In this manner, the added physical text from the second location is augmented to the third location. The OT sub-module processes the operation to update the local model of the third computing device 130. In this manner, the local model of the third computing device is synchronized with the local models of the first and second computing devices and the consistency model of the server system.

As discussed herein, the position and movement of physical text placed on the work surfaces are recognized as operations performed on a model within the context of a graphical editor. Each operation is processed to replicate a physical object with an equivalent electronic image and to manipulate a model object and/or a relationship between model objects. In some implementations, a physical object can be replaced by a virtual object.

As described, physical objects placed on a work surface (e.g., either a physical work surface or a virtual work surface) can be manipulated (e.g., deleted, moved, edited, etc.) at any location. Information placed on a work surface can also be stored electronically as long-term documentation.

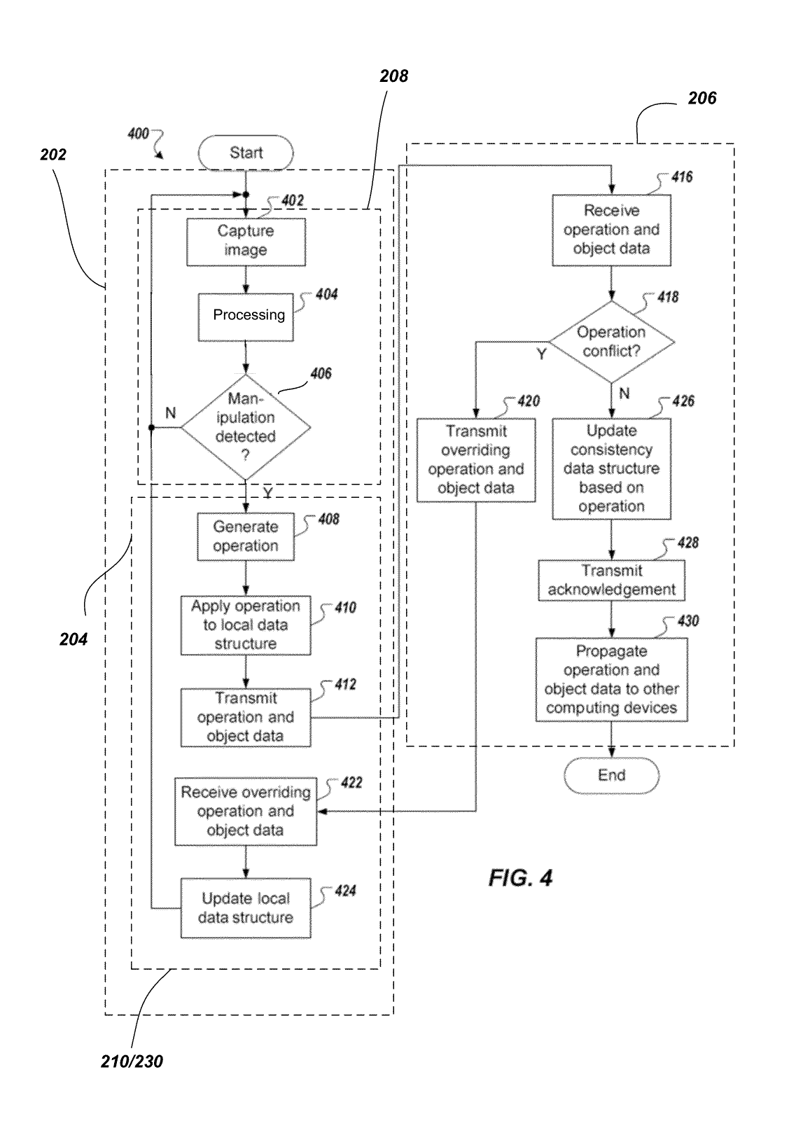

FIG. 4 is a flowchart of an embodiment of a process 400 for a multi-media collaborator. For example, the process facilitates real-time collaboration using physical and virtual work surfaces. The process, as shown, includes steps performed by the system and components described in, for example, FIGS. 1-2. The process may include steps performed by first and second frontend applications 202 and 204 of the computing devices at different locations and backend application 206 of the server system. The first frontend application may be executed by the computing devices with physical work surfaces at the first and second locations and the second frontend application may be executed by the computing device with a virtual work surface at the third location.

A collaboration is instantiated to start the process. At the start, the local models of the work surface are empty. For example, the current local models are empty. The server system also contains a copy of the most current model of the work surface, which at the start is empty. For the case of locations with physical work surfaces, the first frontend application of the computing device captures an image of the local physical work surface at step 402. At step 404, the image is processed. For example, the image is digitized into image data. The image data is analyzed, at step 406 to determine if there is manipulation of the physical work surface, such as addition, deletion, or modification of the physical medium, including text. In the case where manipulation is detected, the process proceeds to step 408. On the other hand, the process loops back to step 402 when no manipulation is detected. These various steps, for example, reflect the steps performed by the image processor module 208 of the first frontend application at the local computing device. For example, the local computing device refers to the computing device at the location at which the physical work surface was manipulated.

At step 408, the browser module generates operations at step 408. The operations can include adding, deleting, modifying one or more objects or a combination thereof. In one embodiment, the objects are related to handwritten text. Other types of objects may also be useful. For example, the local computing device generates operations based on an image of the manipulated physical work surface. In one embodiment, objects are compared with those of the current local model to determine which are different. Those that are different are used to generate the operations. The operations are applied to a local data structure of the local computing device at step 410.

For the case of a virtual work surface, operations are generated when a manipulation of the virtual work surface is detected by the local computing device. For example, the third computing device detects a change in the work surface at the third location. This causes the local computing device to generate operations at step 408 and applying them to the local data structure at step 410.

In either case, the local frontend application transmits the operations and object data to the server system at step 412. This, for example, may be performed by the OT sub-module. The OT sub-module, as described, is part of the browser module. Providing other configurations of the OT sub-module may also be useful. The operations and the object data are received by, for example, the backend application 206 at the server system at step 416. The backend application determines whether there is an operation conflict at step 418. For example, the server system can process the operations in view of a history of operations to determine whether any of the received operations conflict with a previous operation. A conflict, for example, is an operation on an object by two computing devices.

In the event that there is an operation conflict, the process continues to step 420. An overriding operation and object data are transmitted at step 420 by the server system to the local computing device from which the conflicted operation was sent.

The overriding operation and object data are received at step 422 by the local computing device which originally sent the conflicted operation. The local data structure of the local computing device is updated based on the overriding operation and the object data at step 424. For example, the overriding operation and object data removes the conflicted operation by putting the work surface back to what it was prior to the occurrence of the conflicted operation. For example, the overriding operation places the work surface to the most current model stored at the server system. The process then loops back to step 402.

If there is no operation conflict detected at step 418, the process continues to step 426. At step 426, a consistency data structure at the server system is updated based on the operation received from the local computing device. For example, the server system, which stores and maintains a consistency data structure (i.e., model), applies the operation to the consistency data structure, updating it with the new operation received from the local computing device. The consistency data structure is the most current model. An acknowledgment is transmitted to the local computing device that originally provided the operation at step 428. The operation and object data are propagated to other computing devices participating in the collaboration at step 430. For example, remote computing devices which did not send the operation are provided with the operation and object data. The remote computing devices update their local data structures. In this manner, the local data structures at each of the computing devices can be synchronized.

Embodiments may be employed in various types of use cases. For purposes of illustration, examples of use cases are discussed in detail herein. Examples of use cases may include, for example, business process modeling use cases, business process modeling notation (BPMN) use cases, requirements engineering use cases and supply chain modeling use cases. Other types of use cases may also be included.

Business process modeling is an activity used in enterprise management. In the early stages of business process modeling, designers (i.e., team members) often use a whiteboard and a set of sticky notes (potentially grouped, potentially linked, but not really formal) to define the initial process design. In these early stages, it is important to align views and extract process knowledge from participants. Embodiments of the system support collaborative modeling enable every participant involved in the collaboration to be active. In other words, any team member can modify the workspace design and this modification is replicated at other locations.

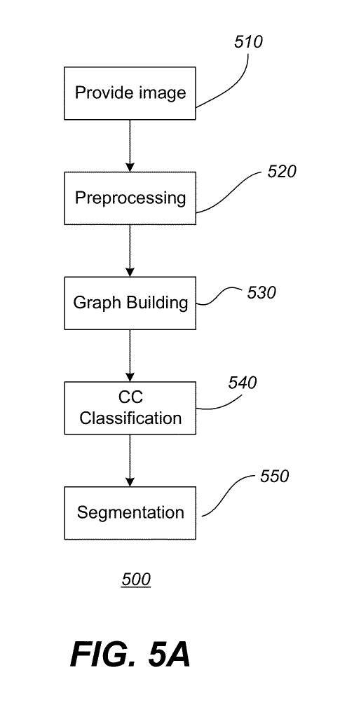

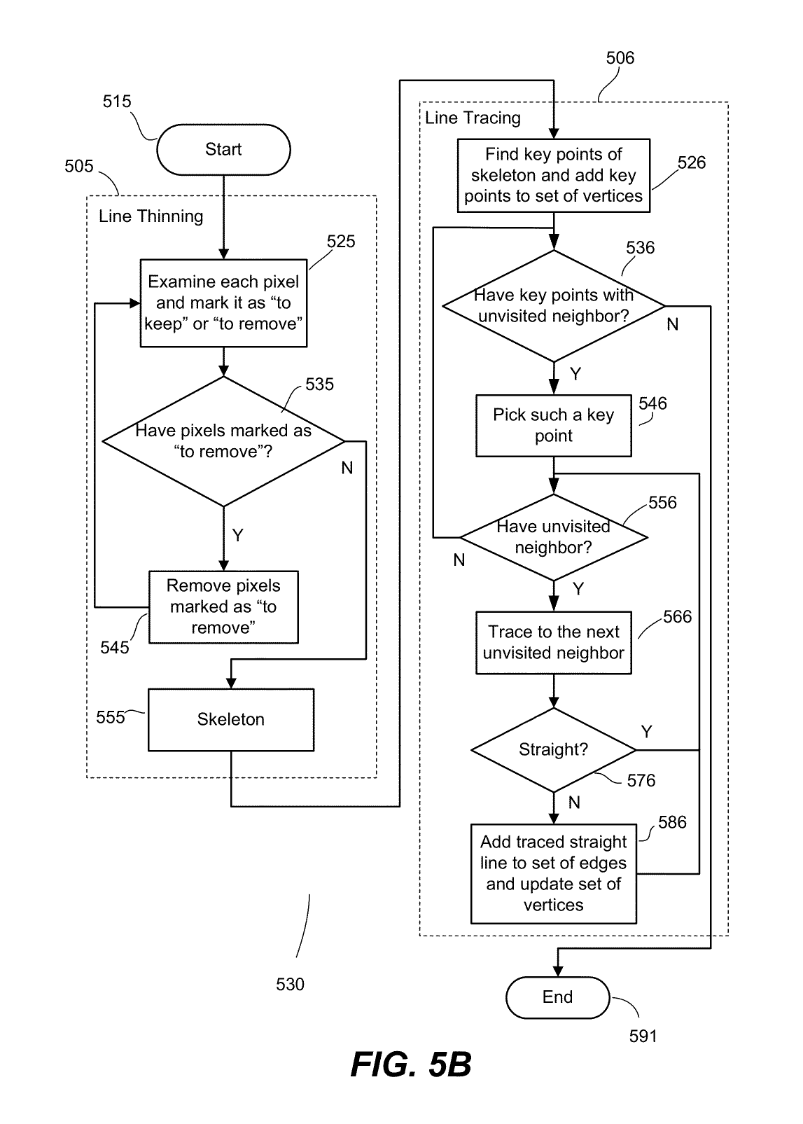

FIG. 5A shows an embodiment of a process 500 for detecting and segmenting handwritten text from unconstrained drawings. In one embodiment, the process employs a modified connected component based (CC-based) technique. At step 510, an input image, for example, of a work surface with handwritten text is provided. The input image, for example, is captured from a digital camera with sufficient resolution. For example, the digital camera should have at least a resolution of about 640×480. Providing digital cameras of other resolutions may also be useful. The input image is preprocessed at step 520. Preprocessing of the input image includes converting the input image to a gray scale (GS) input image. In one embodiment, the input image has a gray scale range from 0-255. For example, the gray scale values are based on 8-bit decoding. Providing other gray scale ranges may also be useful. Each pixel of the input image is assigned a gray scale value, producing the GS input image.

Preprocessing, in one embodiment, further includes transforming the GS image into binary input image. For example, the GS image is transformed into a binary image with first and second GS values. In one embodiment, pixels with a gray scale value above a threshold value will be assigned the highest gray scale value and pixels with a gray scale value at or below the threshold value will be assigned the lowest gray scale value. For example, in the case of the GS range from 0 to 255, above the threshold will be assigned a GS value of 255 and at or below will be assigned a GS value of 0. Other approaches for binarizing the GS image may also be useful.

In one embodiment, binarizing the GS input image employs adaptive thresholding. Adaptive thresholding is used to separate desirable foreground hand-drawings from the background. Adaptive thresholding, for example, includes providing a threshold for each pixel which is calculated by a mean function over a block of neighboring pixels, such as a 5×5 block. Employing adaptive thresholding improves accuracy in detecting handwritten text.

At step 530, a graph is built based on the binary image. The graph represents all drawings or objects in the image, including handwritten text. In one embodiment, graph building includes line thinning. Line thinning is employed to reduce the thickness of lines in the binary image. For example, line thinning reduces the thickness of lines to one pixel. This facilitates in obtaining the most fundamental information about shapes without destroying connectivity. For example, line thinning produces a skeleton of the drawings in the binary image.

In one embodiment, line thinning is performed using Hilditch thinning technique. Hilditch thinning technique is described in, for example, Hilditch, “Linear skeletons from square cupboards,” Machine Intelligence, vol. 4, pp. 403-420, 1969, which is herein incorporated by reference for all purposes. Using other thinning techniques may also be useful.

The Hilditch thinning technique is a parallel-sequential process. At each pass, every pixel is examined in its 3×3 neighborhood to determine whether the pixel is removed or not. A decision to remove or not is based on the patterns of the neighborhood. For example, isolated, end-point, and non-boundary pixels should not be removed. Additionally, a pixel should not be removed if removing it will damage connectivity. On the other hand, pixels are removed for two-pixel wide lines. Pixels which are to be removed are marked. After all pixels of the image are investigated, the marked pixels are removed at the end of the current pass. Multiple passes are required to repeat this process until no pixels are removed.

Line tracing is performed on the skeleton of the drawings after line thinning to build the graph. Line tracing vectorizes the skeleton, converting it to vector representations. In one embodiment, line tracing to build a graph upon the skeleton is based on a chord property technique. Such techniques are described in, for example, Parker, “Extracting vectors from raster images,” Computers and Graphics, vol. 4, pp. 403-420, 1969; and Rosenfeld, “Digital straight line segments,” IEEE Transactions on Computers, vol. c-23, no. 12, 1974, which are herein incorporated by reference for all purposes.

Line tracing identifies key points, such as end points and junction points. An end point pixel has only 1 immediate neighbor in its 3×3 neighborhood while a junction point has at least 3 immediate neighbors. Lines are traced between key points. For example, tracing starts from an end point to an end point, from an end point to a junction point, or from a junction point to a junction point. The lines between key points are arbitrary curves. A curve can be approximated by a set of straight lines connecting one another, for example, by key points.

In one embodiment, chord property is used to trace straight lines. Straight lines, for example, are edges of the graph while end points of straight lines are vertices of the graph. A graph has a set of vertices V and edges E.

In accordance with one embodiment, graph building includes identifying key points K of a skeleton, such as end and junction points. For each vertex v in K, the following is performed:
i. set p=v;
ii. trace top's unvisited immediate neighbor n;
iii. check straightness from v to n using chord property,
   a. if straight, go to step iv,
   b. else go to step v;
iv. a. if nεK, add edge vn to E,
   b. else set p=n and go to step ii;
v. add p to V, add edge vp to E, set v=p and go to step iii.

Immediate neighbors refer to the 8 neighboring pixels in the 3×3 neighborhood of a pixel while p and n are two pointers walking along a line starting from v. The chord property is checked at each step of the walk and different actions are taken depending on the straightness.

Chord property can be expressed using a chain code sequence. For example, a chain code from 0-7 is assigned to the eight neighboring pixels of each pixel. A line segment can be expressed as a sequence of chain codes. A line is digitally straight if its chain code sequence has at most two values differing by ±1. Additionally, for one of the values, the run-length must be 1 and for the other one, there can be at most two run-lengths that are consecutive integers. However, in accordance with one embodiment, the chord property is relaxed. The relaxed chord property allows more different run-lengths for one or the two chain code values. For example, run-lengths of 5 consecutive integers are allowed for one of the two chain code values. Other run-lengths may also be useful. Relaxing the chard property takes into account of hand drawings, reducing the complexity of the graph in a reasonable manner.

The process continues to perform connected component (CC) classification at step 540. An image may include multiple CC components. For example, an image may include y CC components. A CC component CC_{X}, where x is from 1 to y, is a sub-graph of the whole graph. A CCₓ component has a set of vertices V_{X} and a set of edges Eₓ. The vertices of a CC are connected. For example, any two vertices of a CC are connected to each other by paths and not to any additional vertices.

In one embodiment, connected component classification includes computing geometric properties of connected components of the graph to derive text classification scores. For example, geometric properties of each CC are computed. The computation produces a classification score for the classification of text for each CC.

In one embodiment, computed geometric properties of a CC include vertices, bounding box, centroid, edge length, edge density and graph density. For example, the graph properties calculated include the number of vertices, number of edges, number of junction vertices, bounding box, centroid, total edge length, edge density and graph density. In one embodiment, a junction vertex is a vertex with at least 3 edges while a non junction vertex is one with 2 or less edges. A bounding box is the upright rectangle enclosing all vertices, a centroid is the mean of all vertices, total edge length is the sum of the length of all edges while edge density is the ratio of total edge length to area of the bounding box. As for graph density dₓ, in one embodiment, it is defined as:

$${d}_{x} = \frac{2 \vert {E}_{x} \vert}{\vert {V}_{x} \vert ( \vert {V}_{x} \vert - 1 )}$$

where |Eₓ| and |Vₓ| are number of edges and number of vertices of a CCₓ.

The classification score is a sum of different sub-scores. In one embodiment, sub-scores include a standard support vector machine (SVM) classifier, aspect ratio, edge density and neighbor similarity sub-scores. SVM classifier is a machine learning technique for analyzing data to learn patterns therefrom. For example, SVM classifier can be trained to learn from text and non-text samples to build a model.

The SVM classifier score is as follows:

$${S}_{x} \{ \begin{matrix}{k}_{s} \\ - {k}_{s}\end{matrix}$$

The features used in calculating SVM are the number of vertices, number of edges, number of junction vertices, width and height of the bounding box, total edge length, edge density and graph density. In one embodiment, kₛ is a predefined parameter. For example, kₛ=0.3. Providing other values for kₛ may also be useful. The score S is positive kₛ if CCₓ is classified as text, otherwise, it is equal to −kₛ.

The aspect ratio score Aₓ is as follows:

$${A}_{x} \{ \begin{matrix}- {k}_{A} \\ 0\end{matrix}$$

The features used in calculating Aₓ are the height (hₓ) and width (wₓ) of the bounding box for a CCₓ. For example, Aₓ is related to hₓ/wₓ. For example, the score Aₓ is assigned a negative value (−k_{A}) if hₓ/wₓ is less or greater than lower and upper threshold limits, while at or within the limits Aₓ would be 0. The value k_{A} is a predefined value. For example, k_{A}=1. Providing other values for k_{A} may also be useful. In one embodiment, the lower limit is 0.05 and the upper limit is 20. Providing other limits may also be useful.

The edge density score D_{X} is as follows:

$${D}_{x} \{ \begin{matrix}- {k}_{D} \\ 0\end{matrix}$$

The feature used in calculating D_{X} is edge density dₓ. If dₓ is less than a threshold, the score Dₓ is assigned a negative value (−k_{D}), otherwise Dₓ is 0. The value k_{D} is a predefined value. In one embodiment, k_{D} is equal to 10−dₓ*100. Other values for k_{D} may also be useful. In one embodiment, the threshold is 0.1. Providing other threshold values may also be useful.

The features related to aspect ratio and edge density are already included in the calculation of Sₓ. These features, however in one embodiment, are furthered employed to provide penalties to shapes which are unlikely to be text. This improves accuracy to determining that a shape is related to text.

As for neighboring similarity score M_{xy}, it is based on similarity of neighboring CCs. A CCₓ may have a neighboring CC_{y}. The neighboring similarity score M_{xy} and its variables are as follows:

$${M}_{xy} \{ \begin{matrix}{c}_{xy} {w}_{xy} {h}_{xy} \\ 0\end{matrix} \\ {c}_{xy} = \frac{2 ‖ {c}_{x} - {c}_{y} ‖}{{w}_{x} + {h}_{x} + {w}_{y} + {h}_{y}} \\ {w}_{xy} = \frac{max ( {w}_{x} , {w}_{y} )}{min ( {w}_{x} , {w}_{y} )} \\ {h}_{xy} = \frac{max ( {h}_{x} , {h}_{y} )}{min ( {h}_{x} , {h}_{y} )}$$

where cₓ and c_{y} are centroids of CCₓ and CC₃, and wₓ, w_{y}, hₓ and h_{y} are widths and heights of their bounding boxes.

In one embodiment, the similarity score Mxy is =c_{xy}w_{xy}h_{xy} if c_{xy}<1.5, w_{xy}<2 and h_{xy}<3, otherwise it is equal to 0. Providing other Mxy values based on different c_{xy}, w_{xy} and h_{xy} values may also be useful.

The total classification score of CCₓ is the sum of all sub-scores. If the total classification score exceeds a sum threshold, CCₓ is classified as text. Otherwise, CCₓ is classified as non-text. In one embodiment, the sum threshold is zero. For example, if the total classification score of CCₓ is greater than 0, it is classified as text. Otherwise, CCₓ is classified as non-text. Connected components classified as text are detected text components.

After CC classification, detected text components are segmented at step 550. For example, contours of detected text components are used to segment text pixels from the image. The contours are generated using, for example, convex hull algorithm. Convex hull algorithms, for example, are described in Sklansky, “Finding the Convex Hull of a Simple Polygon.” Pattern Recognition Letters, vol. 1, pp. 79-83, 1982), which is herein incorporated for all purposes. For example, a contour of a detected text component is filled, dilated by a 5×5 kernel and also morphologically closed by a 3×3 kernel, forming a mask. In one embodiment, text pixels are segmented from the binarized image using the mask. Alternatively, text pixels are segmented from the input image. For example, text pixels are segmented from the captured image of the work surface.

The segmented CCs are objects which may be compared to objects in the current local data structure. The objects which are different from the local data structures form operations for updating the local data model. The operations are, for example, propagated to the server system for updating of the consistency data structure and propagation to other computing devices of the collaboration.

FIG. 5B shows an embodiment of a process 530. The graph building process starts at step 515. The graph building process includes line thinning and line tracing 505 and 506. In one embodiment, line thinning includes, at step 525, examining each pixel in the binary image to determine whether a pixel remains or is to be removed. After all pixels of the binary image have been examined, the process proceeds to step 535. At step 535, the process determines if there is any pixel in the image which is marked for removal. If there are pixels which marked for removal, the process continues to step 545 for pixel removal. Pixel removal, for example, includes setting the pixels marked for removal to 0 in the GS range. After pixel removal the process returns to step 525. On the other hand, if no pixels are marked for removal in the current pass, the process proceeds to step 555, indicating completion of the skeleton of the binary image.

The process continues to perform line tracing. At step 526, key points in the skeleton are identified and added to a set of vertices. The process determines if there are any key points with unvisited neighbors at step 536. If there are no key points with unvisited neighbors, the process proceeds to step 591 where it is terminated.

In the case that there are key points with unvisited neighbors, the process continues to step 546. At step 546, one of the key points with unvisited neighbors is selected for tracing. After the key point is selected, the process determines if the selected key point has an unvisited neighbor at step 556. If there are none, the process loops back to step 536.

In the case where there are unvisited neighbors, the process proceeds to step 566. At step 566, a trace to the next unvisited neighbor is performed. At step 576, the process determines if the trace is a straight line. For example, the process determines if the trace is a straight line or not using relaxed chord property. If the line is straight, the process returns to step 556. On the other hand, if the line is not straight, the process proceeds to step 586, where the traced straight line is added to the set of edges and the set of vertices are updated, and the process returns to step 556 to restart tracing.

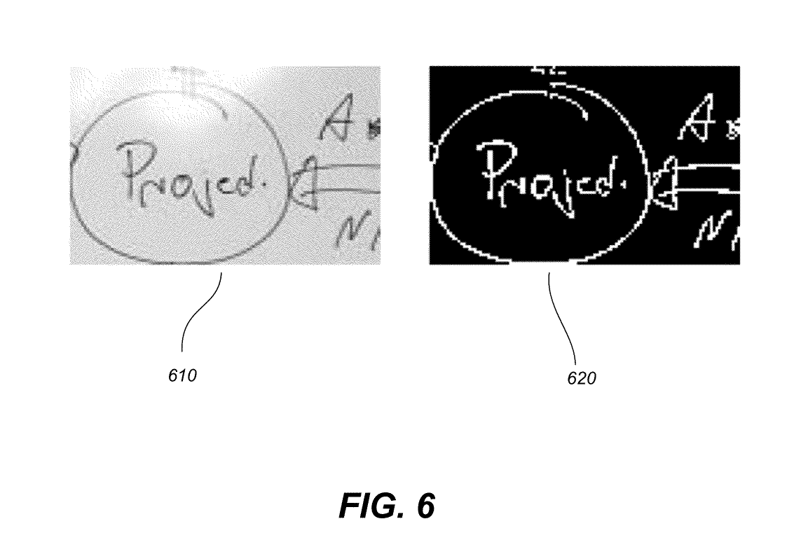

FIG. 6 illustrates an example of a binary image of a physical work surface. The digital image is, for example, captured by a digital camera. The image includes handwritten text as well as other objects. The digital image is processed to provide a GS image 610. The GS image, for example, has pixels with a gray scale range from 0-255. The GS image is processed to form a binary image 620. For example, pixels with a GS value of greater than a threshold value is assigned a GS value of 255 while those below are assigned a GS value of 0. As shown, the binary image has lines which are white and non-lines being black. Providing lines which are black and non-lines being white may also be useful.

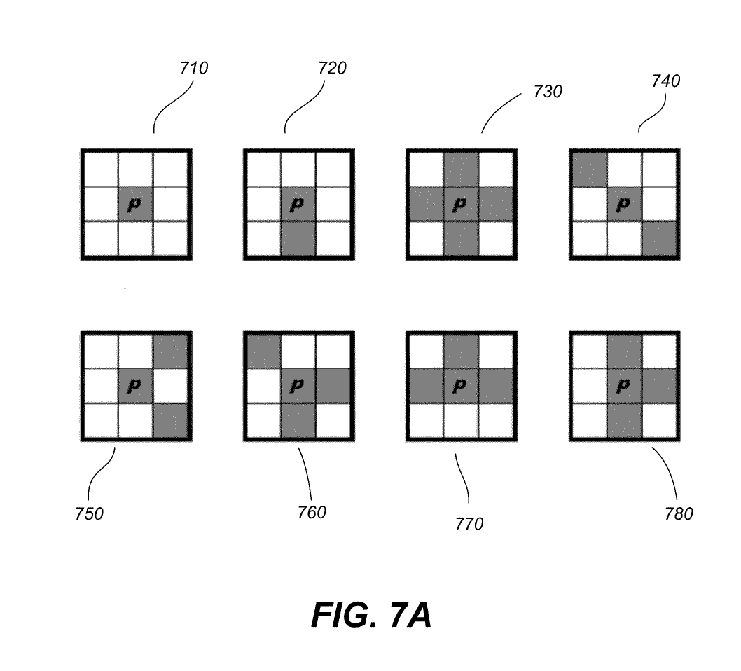

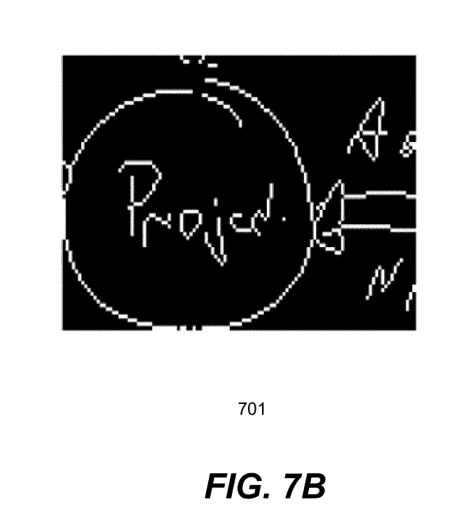

FIG. 7A illustrates various types of pixel conditions encountered in line thinning to reduce thickness of lines in the binary image. In one embodiment, line thinning is achieved using the Hilditch technique. When a pixel is analyzed for line thinning, the pixel is analyzed along with its 8 neighboring pixels. For example, a 3×3 pixel array is analyzed for line thinning, with the center pixel being the pixel of interest and the surrounding pixels being its immediate neighbors in the 3×3 array.

A first 3×3 pixel array 710 reflects an isolated pixel condition. For example, the pixel at the center of the array is darkened while none of its surrounding pixels are. A second 3×3 pixel array 720 reflects an end-point condition. The end point condition exists when the pixel under analysis and only one of its neighboring pixels are darkened. A third 3×3 pixel array 730 reflects a non-boundary condition. For example, the pixel and pixels of each side surrounding the pixel are darkened. Fourth, fifth and sixth pixel arrays 740, 750 and 760 show pixels with connective conditions. Under connective conditions, removal of the center pixel P would result in damaging connectivity of the neighboring pixel. As for seventh and eighth pixel arrays 770 and 780, they show two pixel wide lines. In such cases, one side pixel is removed to reduce the thickness of the line.

FIG. 7B shows a binary image 701 after line thinning. Line thinning produces a skeleton of the binary image. For example, the skeleton is produced after removing pixels so there are no lines which are more than one pixel wide.

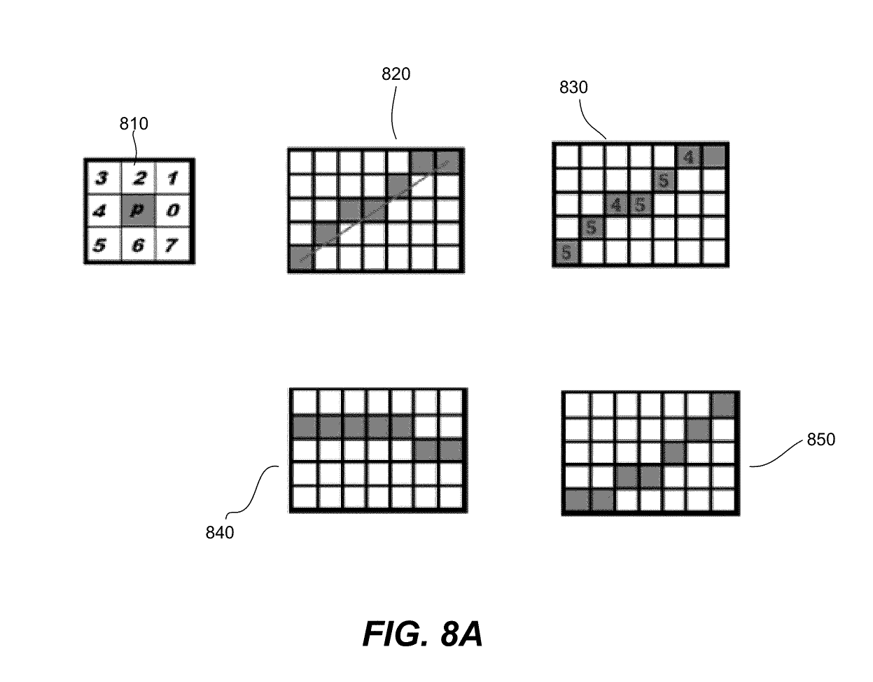

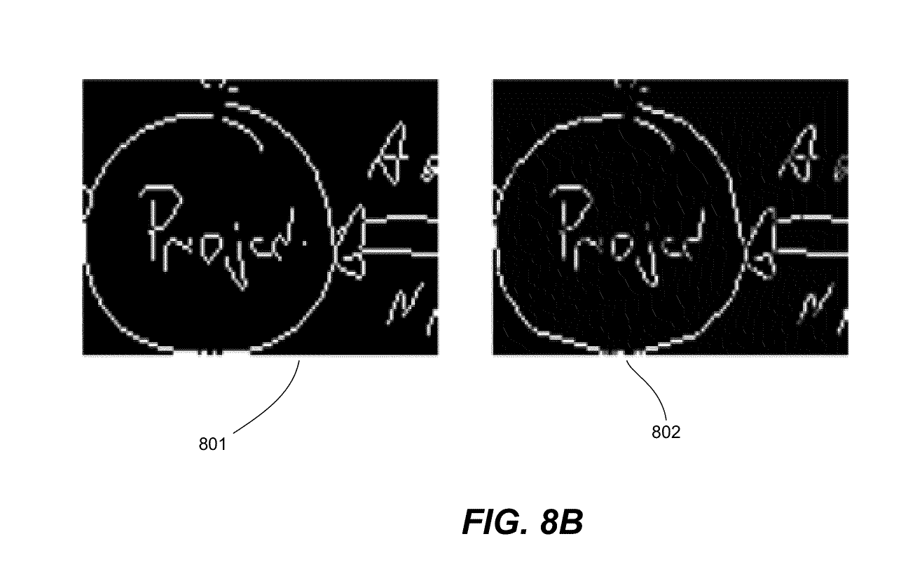

FIG. 8A shows examples of line tracing using chord property to build a graph. As shown, a 3×3 pixel array 810 with chain code assigned to the 8 neighboring pixels. A digital line segment 820 is shown. The digital line segment is compared to a real line. Using the chain code, the chain code sequence from the top right corner is shown in digital line segment 830. The chain code sequence is equal to 455455. Examples of digital line segments 840 and 850 are shown traced using relaxed chord property.

Referring to FIG. 8B, first and second images 801 and 802 are shown. The first image is a binary image 801 after line thinning. For example, the image includes a skeleton produced from line thinning. The second image 802 is the graph built upon the skeleton in 801, with vertices having darker color.

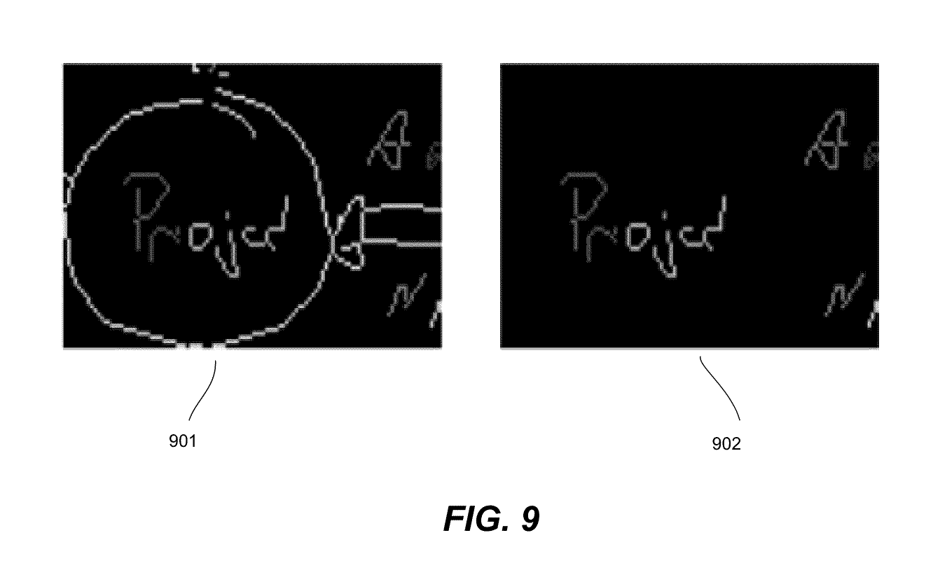

FIG. 9 shows first and second images 901 and 902. The first image includes identified CCs. For purpose of illustrations, different CCs may be assigned different colors. The identified CCs are classified as text or non-text. As shown in the second image, non-text CCs are removed from the image, leaving CCs which are classified as text.

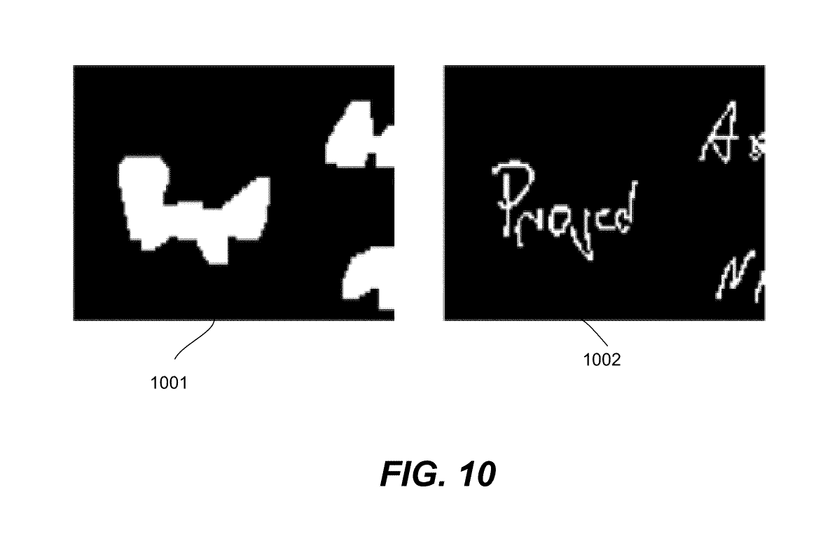

In FIG. 10, first and second images 1001 and 1002 are shown. The first image shows contours of text CCs. The contours, for example, are filled, creating masks. The pixels of the text CCs are segmented from the binary image using the masks. The second image shows the segmented text.

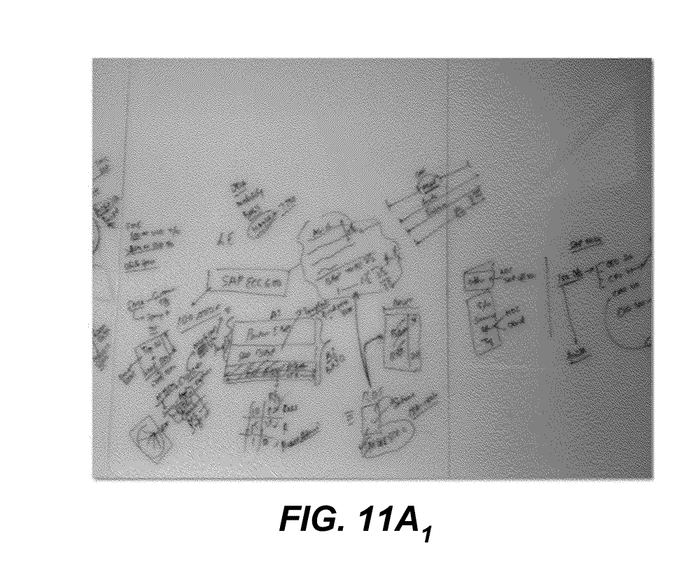

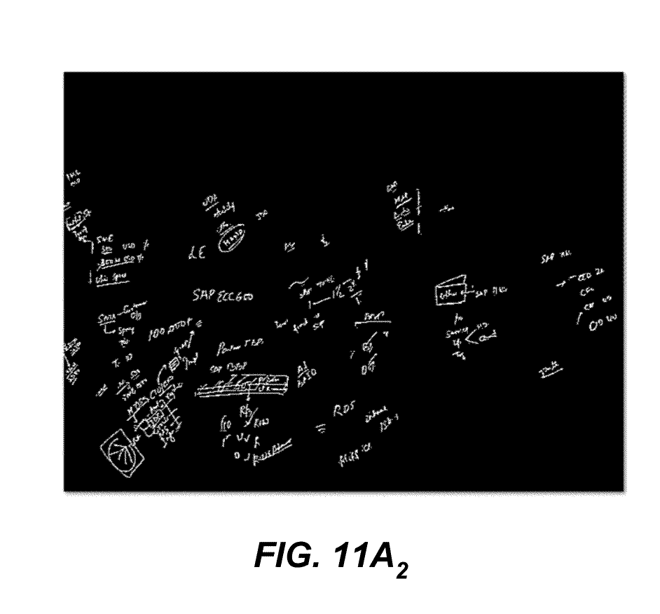

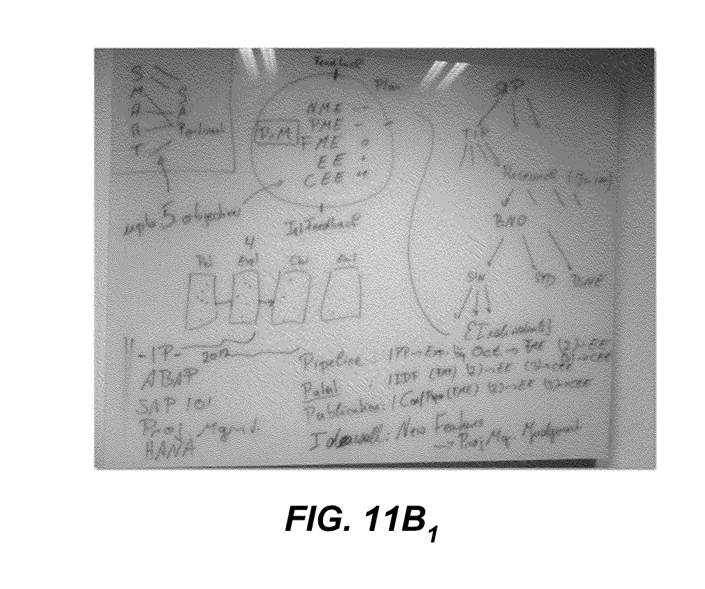

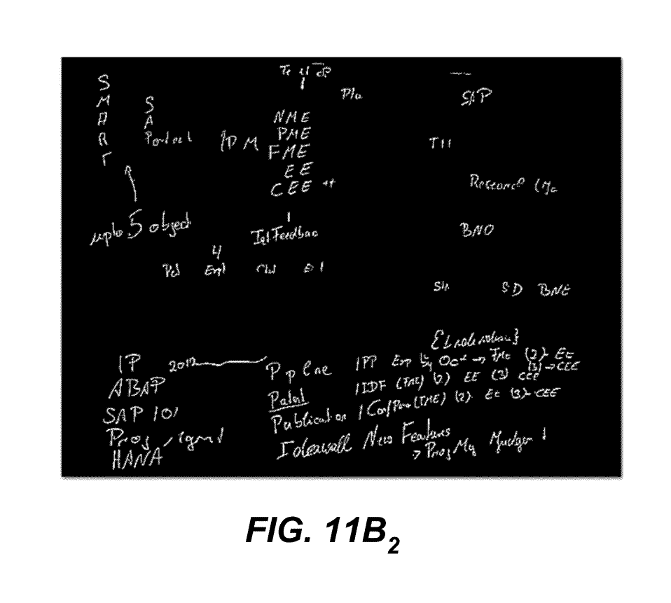

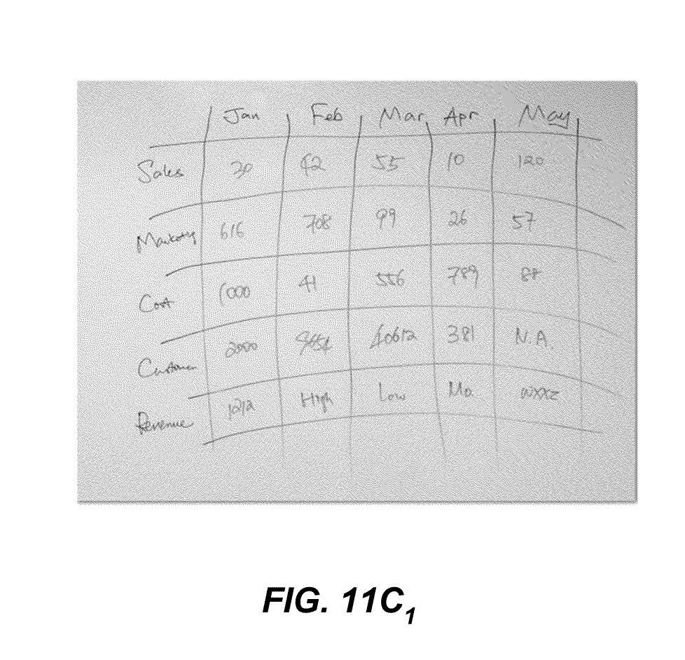

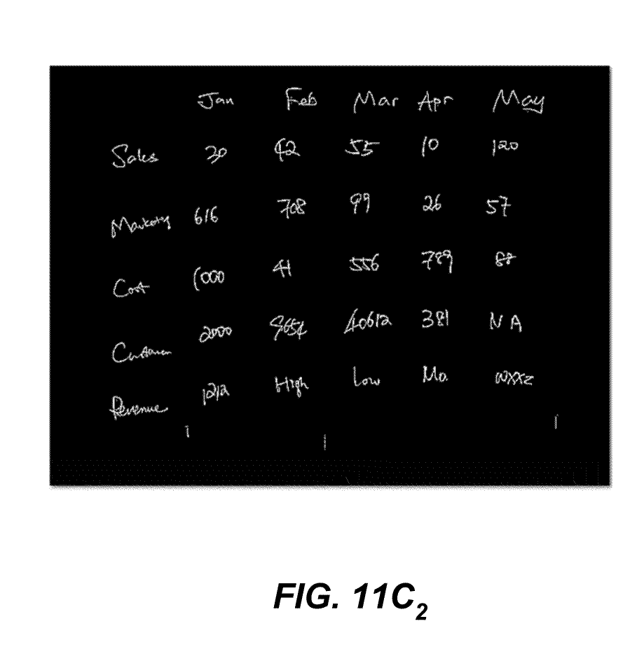

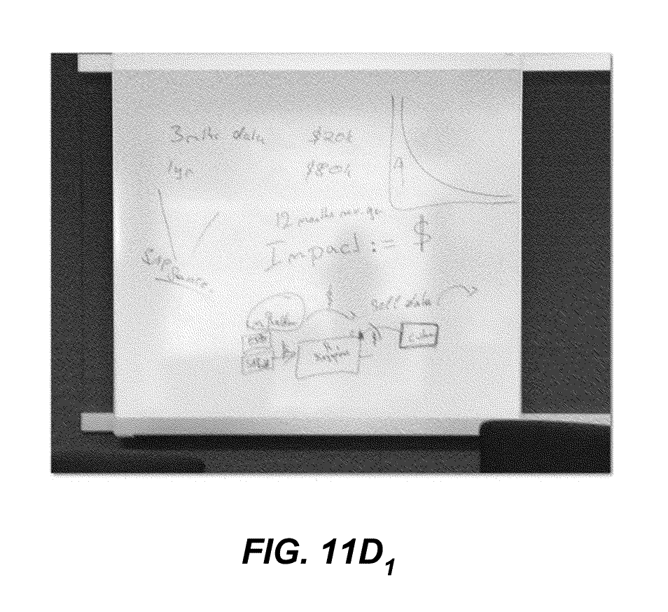

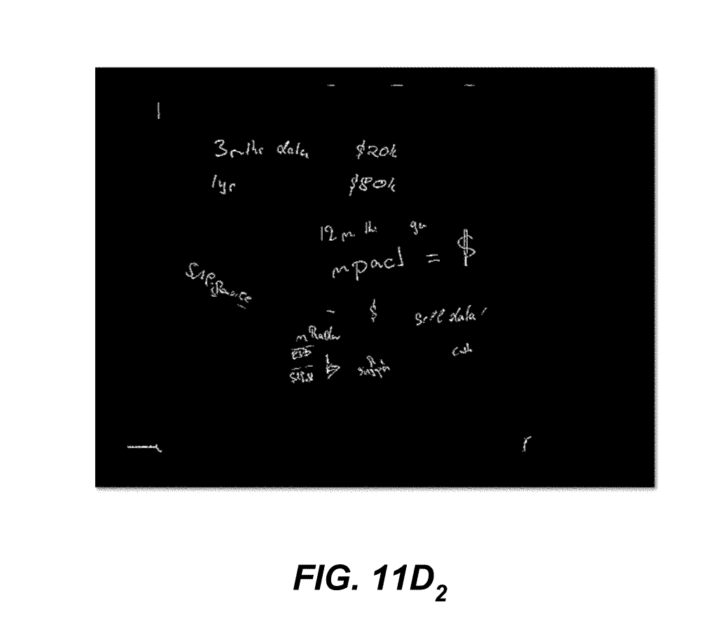

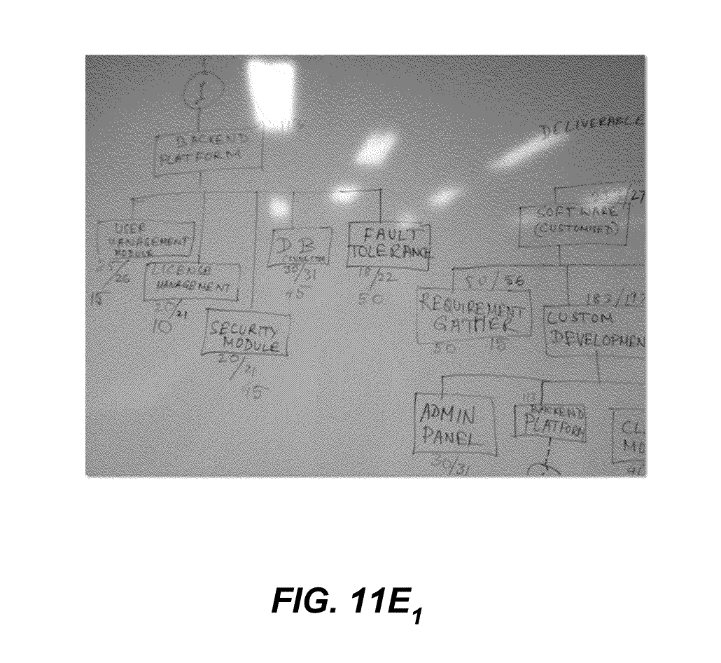

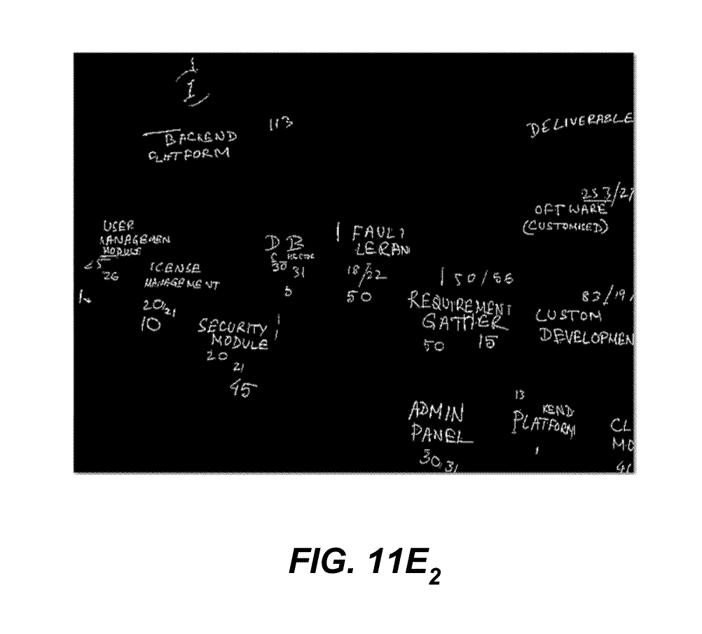

FIGS. 11A₁-E₁ show digital images of a work surface and FIGS. 11A₂-E₂ show results of text segmentation, as described herein. The results indicate that text segmentation achieves high accuracy in a millisecond time scale.

In one embodiment, the multi-media collaborator may be integrated as part of a business or enterprise tool. In other embodiments, the multi-media collaborator may be a stand-alone tool. Other configurations of the multi-media collaborator may also be useful.

The multi-media collaborator may be embodied as an application. For example, the multi-media collaborator may be embodied as a software application. The software application may be integrated into an existing software application, an add-on or plug-in to an existing application, or as a separate application. The existing software application may be a suite of software applications. The source code of the multi-media collaborator may be compiled to create an executable code. The codes of the multi-media collaborator, for example, may be stored in a storage medium, such as one or more storage disks. Other types of storage media may also be useful.

As described, the multi-media collaborator detects and segments text from a work surface. In other embodiments, the multi-media collaborator also detects sticky notes on a work surface. Detection of sticky notes is described in co-pending U.S. patent application Ser. No. 13/160,996, titled SYSTEMS AND METHODS FOR AUGMENTING PHYSICAL MEDIA FROM MULTIPLE LOCATIONS which is herein incorporated for all purposes. In one embodiment, the process detects and sticky notes first and then text detection. Addition sub-modules may be included in the front end and back end applications for sticky note detection.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer implemented method for multi-media collaboration comprising:
providing, at a local location of a collaboration, a digital image with hand drawings;
forming a graph from the digital image;
identifying connected components (CCs) in the graph;
classifying text CCs in the graph;
segmenting the text CCs from the graph; and
propagating objects and data of the text CCs to participants of the collaboration at other remote locations.

2. The computer implemented method of claim 1 comprising:
preprocessing the digital image to produce a binary image; and
forming a graph from the binary image.

3. The computer implemented method of claim 2 wherein forming a graph comprises:
performing line thinning on the binary image to form a skeleton; and
performing line tracing on the skeleton.

4. The computer implemented method of claim 3 wherein performing line thinning comprises:
examining pixels of the binary image;
determining one or more pixels to remove from the binary image;
removing pixels determined to be removed; and
repeating examining, determining and removing pixels until no pixels are determined to be removed.

5. The computer implemented method of claim 4 wherein the line thinning comprises Hilditch thinning technique.

6. The computer implemented method of claim 4 wherein performing line tracing comprises:
finding key points in the skeleton to form a set of vertices;
determining key points with unvisited neighbors;
selecting one key point from the key points with unvisited neighbors;
tracing from the selected key point with unvisited neighbors to next unvisited neighbors; and
determining if the trace is a straight line or not,
if straight, repeat trace to next unvisited neighbors,
if not straight, add traced straight line to set of edges and update set of vertices, and
then restart trace to next unvisited neighbors.

7. The computer implemented method of claim 6 wherein the line tracing comprises relaxed chord property technique.

8. The computer implemented method of claim 6 wherein performing line tracing identifies CC components.

9. The computer implemented method of claim 1 wherein the CC classification comprises computing geometric properties of connected components of the graph to derive text classification scores for the CCs.

10. The computer implemented method of claim 9 wherein the geometric properties comprise vertices, bounding box, centroid, edge length, edge density, and graph density or a combination thereof.

11. The computer implemented method of claim 10 wherein the text classification scores indicate whether a CC is text or not.

12. The computer implemented method of claim 1 comprising:
determining segmented text CCs that are different from a current work surface model; and
propagating objects and data of the different text CCs to participants of the collaboration at other remote locations.

13. The computer implemented method of claim 1 wherein the digital image is of a physical work surface at the local location and remote locations which comprises physical work surfaces, virtual work surfaces or a combination thereof.

14. A non-transitory computer-readable medium having stored thereon program code, the program code executable by a computer to perform:
capturing a digital image with hand drawings at a local location;
forming a graph from the digital image;
identifying connected components (CCs) in the graph;
classifying text CCs in the graph; and
segmenting the text CCs from the graph.

15. The non-transitory computer-readable medium of claim 14 wherein the program code executable by the computer to further perform propagating objects and data of the segmented text CCs to participants of the collaboration at other remote locations.

16. The non-transitory computer-readable medium of claim 14 wherein the program code executable by the computer to further perform:
determining segmented text CCs that are different from a current work surface model; and
propagating objects and data of the different text CCs to participants of the collaboration at other remote locations.

17. The non-transitory computer-readable medium of claim 14 wherein classifying text CCs comprises computing geometric properties of CCs of the graph to derive text classification scores for the CCs.

18. A multi-media collaboration system comprising:
a non-transitory memory device for storing computer-readable program code; and
a processor in communication with the memory device, the processor being operative with the computer-readable program code to perform:
capturing a digital image with hand drawings by a digital camera in communication with the processor,
forming a graph from the digital image,
identifying connected components (CCs) in the graph,
classifying text CCs in the graph, and
segmenting the text CCs from the graph.

19. The multi-media collaboration system of claim 18 wherein the processor being operative with the computer-readable program code to further perform propagating objects and data of the segmented text CCs to participants of the collaboration at other remote locations.

20. The multi-media collaboration system of claim 18 wherein the processor being operative with the computer-readable program code to further perform:
determining segmented text CCs that are different from a current work surface model; and
propagating objects and data of the different text CCs to participants of the collaboration at other remote locations.
